(19) United States
(12) Patent Application Publication
(10) Pub. No.: US 2025/0060955 A1
(43) Pub. Date: Feb. 20, 2025

(54) METHOD FOR UPGRADING HOME APPLIANCE, AND DEVICE IMPLEMENTING SAME

(71) Applicant: LG ELECTRONICS INC., Seoul (KR)

(72) Inventors: Ju Hyun PARK, Seoul (KR); In Sung JUNG, Seoul (KR); Chan Sung JEON, Seoul (KR)

(21) Appl. No.: 18/725,090

(22) PCT Filed: Apr. 7, 2022
(86) PCT No.: PCT/KR2022/005020

§ 371 Date: Jun. 27, 2024

(30) Foreign Application Priority Data
Dec. 31, 2021 (KR) 10-2021-0194665
Jan. 24, 2022 (KR) 10-2022-0009875

(51) Int. Cl. G06F 8/65

(52) U.S. Cl. CPC G06F 8/65

(57) ABSTRACT

Disclosed are a method for upgrading software of a home appliance, and a device implementing same. During the process of upgrading a plurality of software, the disclosed home appliance can collectively download a plurality of pieces of software data and then record the plurality of pieces of downloaded software data. In particular, the download may be performed in a hidden manner. Accordingly, even when the upgrade of the home appliance fails, the home appliance can be used normally, and from the perspective of a user, the upgrade time may be shortened.

### CROSS-REFERENCE TO RELATED APPLICATIONS

This application is a National Stage application under 35 U.S.C. § 371 of International Application No. PCT/KR2022/005020, filed on Apr. 7, 2022, which claims the benefit of Korean Patent Application No. 10-2022-0009875, filed on Jan. 24, 2022 and Korean Patent Application No. 10-2021-0194665, filed on Dec. 31, 2021. The disclosures of the prior applications are incorporated by reference in their entirety.

### TECHNICAL FIELD

The present invention relates to a method of upgrading a home appliance, and a device for implementing the same.

### BACKGROUND ART

A home appliance includes a controller. The controller implements desired functions of users by executing specific software.

Typically, after the home appliance is sold, manufacturers provides only simple support such as fixing program errors. Therefore, when a new home appliance with new functions is released, the user should purchase the new home appliance. In other words, the user should replace the current home appliance with the new home appliance in order to use the new functions, which causes user dissatisfaction. To solve such a problem, the user upgrades the software of the home appliance to improve the functions of the home appliance and add functions to the home appliance.

### DISCLOSURE

### Technical Problem

The present invention is directed to providing a method of upgrading software so that download of the software of a home appliance may be performed without failure, and a device for implementing the same.

In addition, the present invention is directed to providing a method of performing seamless upgrade of the home appliance, and a device for implementing the same.

In addition, the present invention is directed to providing a method of shortening a performing time of the upgrade, and a device for implementing the same.

Objects of the present invention are not limited to the above-described objects, and other objects and advantages of the present invention which are not mentioned can be understood by the following description and more clearly understood by embodiments of the present invention.

### Technical Solutions

A method of upgrading a home appliance according to one embodiment of the present invention may collectively download a plurality of pieces of software data and then collectively write (i.e., record) the plurality of pieces of downloaded software data in a process of upgrading the plurality of pieces of software.

In addition, the method of upgrading the home appliance according to one embodiment of the present invention may include continuously downloading (taking over) the plurality of pieces of software data when the download of the plurality of pieces of software data is interrupted.

In addition, the method of upgrading the home appliance according to one embodiment of the present invention may including performing the download process of the plurality of pieces of software data by hiding the download process. In other words, the user cannot know that the process of downloading the plurality of pieces of software data is performed.

In addition, a home appliance according to one embodiment of the present invention includes a communication unit configured to communicate with a management server, and a controller in which software is installed. In this case, the communication unit may transmit an inquiry message of upgrade software to the management server based on a preset upgrade schedule and download upgrade software data transmitted from the management server based on the inquiry message.

In addition, a method of upgrading software of a home appliance including a communication unit and a controller according to one embodiment of the present invention includes (a) checking, by the communication unit, whether upgrade software is present in a management server based on a preset schedule, (b) automatically downloading, by the communication unit, the upgrade software data from the management server and storing the upgrade software data in a storage of the communication unit when upgrade software data corresponding to the upgrade software is registered in the management server, (c) notifying, by the communication unit, the completion of the download of the upgrade software data to the management server, and (d) writing, by the communication unit, the downloaded upgrade software in the controller and upgrading the software based on a selection event of a user.

In addition, a management server according to one embodiment of the present invention includes a communication unit configured to communicate with a home appliance, a storage configured to store upgrade software data corresponding to upgrade software executable in the home appliance, and a controller configured to control the communication unit and the storage. In this case, the communication unit may receive an inquiry message of upgrade software transmitted from the home appliance based on a preset upgrade schedule, and sequentially upload the upgrade software data to the home appliance based on the inquiry message.

### Advantageous Effects

According to the present invention, by collectively and sequentially performing the downloading and writing the plurality of pieces of software data, all of the plurality of pieces of software data are not written in the home appliance even when the download of the plurality of software is interrupted due to the state of the communication network or the like. Therefore, it is possible to prevent the occurrence of a case in which the home appliance cannot be normally used due to a failure of the upgrade of the home appliance.

In addition, according to the present invention, when the download of the plurality of pieces of software data is interrupted, the plurality of pieces of software data can be subsequently received. Therefore, the ceaseless (seamless) upgrade of the home appliance can be performed.

In addition, according to the present invention, it is possible to hide the download process of the plurality of pieces of software data. In other words, the user may not be aware that the download process of the plurality of pieces of software data is being performed and can check only a message indicating that the upgrade process will be performed after the download process is finished. Therefore, from the perspective of the user, it is possible to shorten the performing time of the upgrade.

Specific effects together with the above-described effects are described together with a description of the following detailed matters for carrying out the invention.

### DESCRIPTION OF DRAWINGS

FIG. 1 is a block diagram illustrating a schematic configuration of a system for upgrading a home appliance according to one embodiment of the present invention.

FIG. 2 is a block diagram illustrating a schematic configuration of the home appliance according to one embodiment of the present invention.

FIG. 3 is a block diagram illustrating a schematic configuration of a user terminal according to one embodiment of the present invention.

FIG. 4 is a block diagram illustrating a schematic configuration of a management server according to one embodiment of the present invention.

FIG. 5 is a flowchart of a method of upgrading the home appliance according to one embodiment of the present invention.

FIG. 6 is a flowchart of a preliminary process of the upgrade of the method of upgrading the home appliance according to one embodiment of the present invention.

FIG. 7 is a flowchart of a download process of the method of upgrading the home appliance according to one embodiment of the present invention.

FIGS. 8 and 9 are views illustrating a display screen of the user terminal, which is displayed to the user, in the upgrade process according to one embodiment of the present invention.

FIG. 10 is a view illustrating specific communication between the management server, the home appliance, and the user terminal according to one embodiment of the present invention.

FIG. 11 is a view illustrating an upgrade process according to another embodiment of the present invention.

### DETAILED DESCRIPTION OF EXEMPLARY EMBODIMENTS

The above-described aspects, features and advantages are specifically described hereunder with reference to the accompanying drawings such that one having ordinary skill in the art to which the present disclosure pertains can easily implement the technical spirit of the disclosure. The invention can be embodied in various forms and is not limited to the embodiments.

In the disclosure, detailed descriptions of known technologies in relation to the disclosure are omitted if they are deemed to make the gist of the disclosure unnecessarily vague. Below, preferred embodiments according to the disclosure are specifically described with reference to the accompanying drawings. In the drawings, identical reference numerals can denote identical or similar components. Description will now be given in detail according to exemplary embodiments disclosed herein, with reference to the accompanying drawings. For the sake of brief description with reference to the drawings, the same or equivalent components may be provided with the same reference numbers, and description thereof will not be repeated.

Terms such as first, second, A, B, (a), and (b) can be used to describe elements of the invention. These terms are merely used to distinguish one element from another element and the essence, order, sequence, number, or the like of the elements is not limited to the terms. If it is mentioned that an element is “linked”, “coupled” or “connected” to another element, it should be understood that the element is directly coupled or connected to another element or still another element may “interposed” therebetween or the elements may be “linked”, “coupled” or “connected” to each other with still another element interposed therebetween.

Throughout the specification, unless otherwise stated, each component may be singular or plural.

The singular expression used herein includes the plural expression unless the context clearly dictates otherwise. In the application, terms such as “composed of” or “comprising” should not be construed as necessarily including all of the various components or operations described in the specification and should be construed as not including some of the components or some of the operations or further including additional components or operations.

In addition, components may be subdivided for convenience of description in implementing the present disclosure, but these components may be implemented in one device or module or one component may be a plurality of devices. Alternatively, it may be implemented by being divided into modules.

Hereinafter, a preferred embodiment according to the present invention will be described in detail with reference to the attached drawings.

First, the upgrade of the home appliance described in the present disclosure refers to the upgrade of software installed in the home appliance. The software may include firmware for operation of a controller (i.e., microcomputer) and a content program executed on the firmware. As one example, the content program may be a program for setting a background screen of a display provided in a washing machine, a program for setting a washing course of the washing machine, and the like.

In addition, the upgrade process is defined as including a download process and a recording process. The download process is a process in which software data for recording software is received and stored in the home appliance. The recording process is a process in which software data stored in the home appliance is recorded (written) to the control unit or microcomputer.

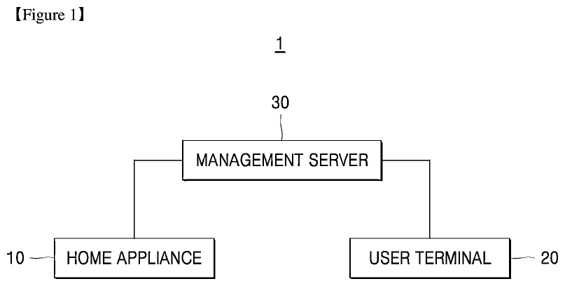

FIG. 1 is a block view showing a schematic configuration of upgrading a system 1 for upgrading a home appliance according to an embodiment of the present disclosure.

Referring to FIG. 1, the system 1 configured to upgrade a home appliance (hereinafter, referred to as “the system”) may include a home appliance 10, a user terminal 20 and a management server 30.

The home appliance 10 may refer to a home appliance or electronic product that is installed in a user's residential space or office space to perform a unique function. As one example, the home appliance 10 may include a refrigerator, a TV, a washing machine, a dryer, an air conditioner, an air purifier, a cloth management device, a microwave oven, an electric range, an oven and the like.

The user terminal 20 may be the user's device and may be a device for transmitting and receiving specific information with the home appliance 10 through the server 30 to perform the upgrade of the home appliance 10. As an example, the user terminal 20 may be a smart device such as a smartphone, a smart watch, or a tablet PC, may be a home hub or artificial intelligence speaker, which is a separate electronic device, and may be a refrigerator, a TV, or the like capable of implementing the interaction with the smart device.

The management server 30 may be a device configured to remotely manage the home appliance 10. The management server 30 may be communicatively connected to the home appliance through a communication network, and configured to manage the home appliance 10 by interworking with the user terminal 20.

Especially, the management server 30 may store information for upgrading the home appliance 10. The information stored in the management server 30 may include data related to the software installed in the home appliance 10, information related to the home appliance 10 and information related to the user. The software data may include data about firmware of the home appliance (i.e., firmware data) and data about a content program executed on the firmware (i.e., content program data).

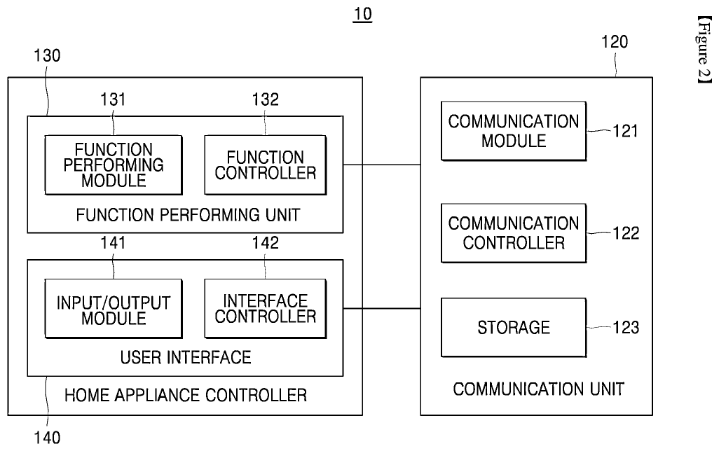

Hereinafter, a configuration of the home appliance 10, the user terminal 20, and the management server 30 will be described in more detail with reference to FIGS. 2 to 4.

FIG. 2 is a block diagram illustrating a schematic configuration of the home appliance 10 according to one embodiment of the present invention.

Referring to FIG. 2, the home appliance 10 may include a home appliance controller 110 and a communication unit 120. The home appliance controller 110 may include a function performing unit 130 and a user interface 140. Meanwhile, the configuration of the home appliance 10 is not limited to FIG. 2, and various additional components may be included in the home appliance 10.

The communication unit 120, the function performing unit 130, and the user interface 140 may transmit and receive data through a local bus.

The home appliance controller 110 may control the overall operation of the home appliance 10. The home appliance controller 110 may correspond to a microcomputer. Depending on functions of the home appliance 10, a plurality of microcomputers may be configured to be in charge of controlling each function and operated based on a plurality of firmware required for each microcomputer.

The communication unit 120 may configured to perform communication with the management server 30.

Specifically, the communication unit 120 may receive firmware data and software data (e.g., content program data) from the management server 30. The communication unit 120 may store the received software data and transmit the stored software data to at least one of the function performing unit 130 or the user interface 140 in home appliance controllers 110.

The communication unit 120 may include a communication module 121, a communication controller 122 and a storage 123.

The communication module 121 may be configured to transceive data. The communication module 121 may transmit and receive data via wire or wirelessly.

According to an embodiment, the communication module 121 may be a short range wireless communication module configured to implement short range wireless communication. The short range communication module may be wireless communication based on WiFi (Wireless Fidelity), Bluetooth, RFID (Radio Frequency Identification), Infrared Data Association, UWB (Ultra-wideband), ZigBee or the like.

When the communication module 121 is a short range wireless communication module, an access point (not shown) may be provided in the user's residential space. The access point may be a device configured to relay wireless communication between the management server 30 and the communication module 121. As one example, when the communication module 121 is a WiFi module, the access point may be a WiFi router.

According to another embodiment, the communication module 121 may be a long distance wireless communication module configured to implement long distance wireless communication. The long distance wireless communication module may be a wireless communication module based on CDMA (code division multiple access), FDMA (frequency division multiple access), TDMA (time division multiple access), OFDMA (orthogonal frequency division multiple access), SCFDMA (single carrier frequency division multiple access), 5G or the like.

The communication controller 122 may control the communication module 121 and the storage 123. The communication controller 122 may correspond to a microcomputer for controlling communication. The communication controller 122 may operate based on firmware.

The communication controller 122 may store the data received from the communication module 121, particularly software data, in the storage 123. In addition, the communication controller 122 may transmit the software data stored in the storage 123 to the function performing unit 130 and the user interface 140 through a local bus.

Although not illustrated in the drawing, the communication controller 122 may include a processor and an internal memory.

The processor may include one or more among a central processing unit (CPU), an application processor, or a communications processor. The processor may be operated based on the firmware to execute one or more instructions related to control of the home appliance 10.

The internal memory may be a volatile and/or non-volatile memory. The internal memory may store the firmware and one or more instructions related to control of the communication unit 120.

The storage 123 may be a volatile and/or non-volatile memory and may store software data received from the communication module 121.

Meanwhile, in the present embodiment, although it has been described that the software data is stored in the storage 123, according to another embodiment, the software data may be stored in some allocated areas (i.e., download areas) among the entire area of the internal memory of the communication controller 122. The communication unit 120 may transmit and write the software data to the memory of the home appliance controller 110 through serial communication so that previously installed software may be updated or software which has not been previously installed may be added. At this time, when rebooting occurs after the transmission of the software data to the memory of the home appliance controller 110 is finished, the download area may be re-allocated as a control area, and the communication controller may perform a writing operation of the upgrade of the software of the home appliance 10. In addition, according to still another embodiment, the software data may be stored in a memory in the home appliance controller 110.

The function performing unit 130 may be a component for performing a unique function provided by the home appliance 10. For example, the unique function may be a washing function of a washing machine, a drying function of a dryer, an air conditioning function of an air conditioner, an air purifying function of an air purifier, or the like.

The function performing unit 130 may include a function performing module 131 and a function controller 132.

The function performing module 131 is a module for performing the above functions and may include a driver, a heater, a cooler, or the like, which includes a motor.

The function controller 132 may control the function performing module 131. The function controller 132 may correspond to a microcomputer for controlling function performance. The function controller 132 may be operated based on the firmware.

Although not illustrated in the drawing, the function controller 132 may include a processor and an internal memory. The processor and the internal memory have been described above.

The user interface 140 may provide operation information of the home appliance 10, information about the upgrade of the home appliance 10, and the like to the user. As an example, the user interface 140 may include a display module and a speaker module. Meanwhile, the user interface 140 may receive an input for controlling the operation of the home appliance 10 from the user.

The user interface 140 may include an input/output module 141 and an interface controller 142.

The input/output module 141 may visually and/or audibly output the operation information and information about the upgrade of the home appliance 10 to the user and receive input information. When the input/output module 141 is a display module, the input/output module 141 may be a display panel.

The interface controller 142 may control the input/output module 141. The interface controller 142 may correspond to a microcomputer for controlling the interface. The interface controller 142 may be operated based on the firmware.

Although not illustrated in the drawing, the function controller 142 may include a processor and an internal memory. The processor and the internal memory have been described above.

Meanwhile, the firmware of the communication controller 122, the firmware of the function controller 132, and the firmware of the interface controller 142 may be different.

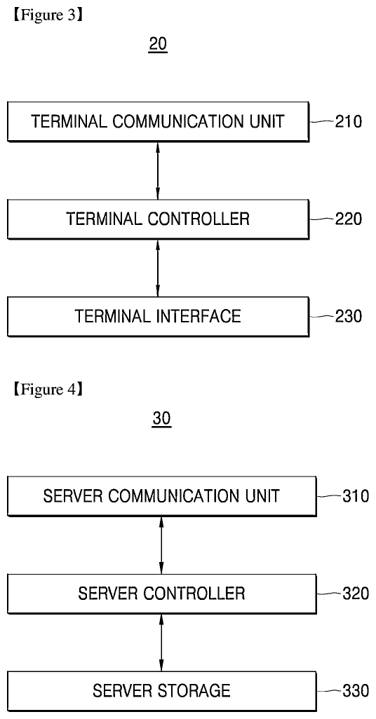

FIG. 3 is a block view showing a schematic configuration of a user terminal 20 according an embodiment.

Referring to FIG. 3, the user terminal 20 may include a terminal communication unit 210, a terminal controller 220 and a terminal interface 230.

The terminal communication unit 210 may be configured to perform communication with the management server 30. The terminal communication unit 210 may perform communication with a wire and/or wirelessly. The wireless communication may include a short range wireless communication and a long distance wireless communication.

The terminal controller 220 may be configured to control the terminal communication unit 210 and the terminal interface 230.

Although not shown in the drawings, the terminal controller 220 may include a processor and an internal memory. An application for a terminal may be stored in the internal memory to manage the home appliance 10. The process may be configured to execute the application for the terminal.

The terminal interface 230 may be configured to output an execution screen of the application for the terminal. Particularly, the terminal interface 230 may visually and/or audibly output information related to the upgrade of the home appliance 10.

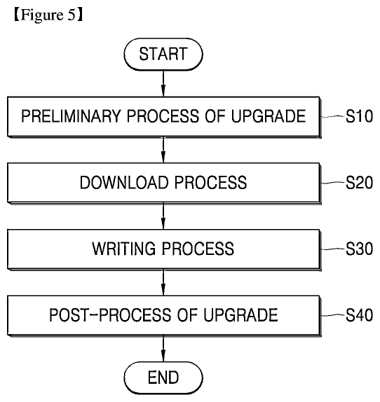

FIG. 4 is a block view showing a schematic configuration of a management server 30 according to an embodiment.

Referring to FIG. 4, the management server 30 may include a server communication unit 310, a server controller 320 and server storage 330.

The server communication unit 310 may be configured to perform communication with the home appliance 10 and the user terminal 20. The server communication unit 310 may perform communication via a wire and/or wirelessly. The wireless communication may include a short range wireless communication and a long distance wireless communication.

The server controller 320 may be configured to control a server communication unit 310 and server storage 330.

Although not shown in the drawings, the server controller 320 may include a processor and an internal memory. The internal memory may be configured to store an application for a server to manage the home appliance 10. The processor may be configured to execute the application for the server.

The server storage 330 may be a volatile and/or non-volatile memory, and it may store information related to the upgrade of the home appliance 10. The upgrade-related information may include data related to the software installed in the home appliance 10, information related to the home appliance 10, information related to the user and the like. The software data may include firmware data and content program data of the home appliance.

Meanwhile, each of the firmware data and the content program data may be stored in the server storage 330 for each version. Particularly, for software upgrade, firmware data of the latest version and content program data may be stored in the server storage 330, respectively.

As described above, the home appliance 10 may include the plurality of controllers (i.e., microcomputers) 122, 132 and 142. Firmware of the plurality of controllers may be different from each other. The server storage 330 may be configured to store firmware data for each of the plurality of controllers 122, 132 and 142.

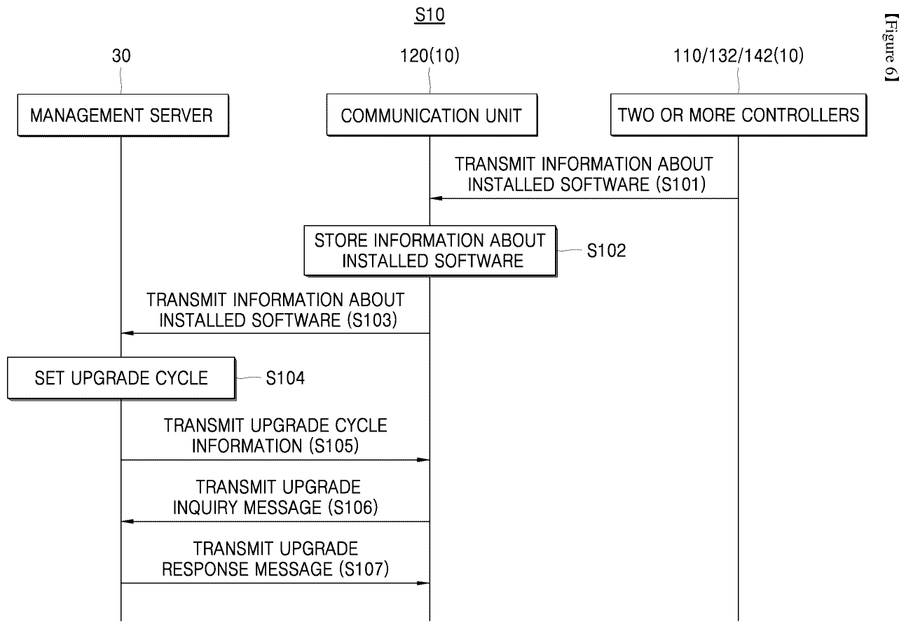

Hereinafter, referring to FIG. 5, a process of upgrading software that is performed in a system 1 will be described.

FIG. 5 is a flow chart showing a method of upgrading a home appliance 10 according to an embodiment.

The upgrade method may be performed for each of a plurality of home appliances 10 possessed by the user. For convenience of description, a software upgrade method for one home appliance 10 is described in FIG. 5.

The software upgrade method may be performed by the co-working of the home appliance 10, the user terminal 20 and the management server 30.

Hereinafter, a process of performing each operation will be described.

In S10, a preliminary process of the upgrade may be performed.

In S10, the home appliance 10 and the management server 30 may be connected by communication, and upgrade-related information may be stored in the server storage 330. Also, an upgrade schedule including an upgrade cycle, an upgrade reservation and the like may be set in S1.

In S20 and S30, the upgrade process may be performed.

First, a download process of the upgrade process may be performed in S20.

Specifically, the management server 30 may transmit software data to the home appliance 10. The software data transmitted by the management server 30 may be transmitted to and stored in the communication unit 120 of the home appliance 10. As described above, the transmitted software data may be firmware data or content program data.

The software data may include two or more firmware data, and the management server 30 may sequentially transmit the two or more firmware data to the home appliance. That is, when two or more of the plurality of controllers 122, 132 and 142 provided in the home appliance 10 are upgraded, the management server 30 may sequentially transmit two or more firmware data corresponding to the two or more controllers to the home appliance 10. The transmission order of the two or more firmware data may be preset. As one example, when the function controller 132 and the interface controller 142 are upgraded, firmware data for the function controller 132 may be transmitted first, and then firmware data for the interface controller 142 may be transmitted.

Alternatively, the software data may include two or more content program data. The management server 30 may sequentially transmit two or more content program data to the home appliance 10. Each of the two or more content program data may be data for a content program performed in at least one of the plurality of controllers 122, 132 and 142 provided in the home appliance 10. The transmission order of the two or more content program data may be preset.

Alternatively, the software data may include at least one firmware data and at least one content program data. In this instance, the management server 30 may sequentially transmit the at least one firmware data and the at least one content program data.

Next, in S30, the recording process of the upgrade process may be performed.

Specifically, the communication unit 120 may write the stored software data in the corresponding one of the plurality of controller 122, 132 and 142. The software may be installed in the controller by being written in the controller.

When the plurality of software data stored in the communication unit 120 include two or more firmware data, the communication unit may write two or more firmware data in the corresponding controllers, respectively. The writing order of the two or more firmware data may be preset. As one example, when the function controller 132 and the interface controller 142 are upgraded, firmware data for the function controller 132 may be first written and then firmware data for the interface controller 142 may be written.

Alternatively, when the plurality of software data stored in the communication unit 120 include two or more content program data, the communication unit may write two or more content program data in corresponding controllers, respectively. The writing order of the two or more content program data may be preset.

Alternatively. When the plurality of software data stored in the communication unit 120 include at least one firmware data and at least one content program data, the communication unit 120 may write at least one firmware data and at least one content program data in corresponding ones of the controllers respectively. The writing order of the at least one firmware data and the at least one content program data may be preset. As one example, when the plurality of software data include firmware data and content program data for the user interface, firmware data may be written first and then the content program data may be recorded.

In S40, a post-upgrade process may be performed.

As one example, in S40, specific functions of the upgraded software may be set. Particularly, when the pluralities of software are upgraded, specific functions for each of the plurality of software may be sequentially set.

Meanwhile, as described above, the method of upgrading the home appliance 10 described in the specification may include collectively and sequentially downloading a plurality of pieces of software data (S20), and collectively and sequentially writing the plurality of pieces of downloaded software data (S30).

In particular, the method of upgrading the home appliance 10 may collectively download the plurality of pieces of software data without user intervention and successively download the plurality of pieces of software data when the download is interrupted. Therefore, even when the upgrade of the home appliance 10 fails, the home appliance 10 can be used normally, and the ceaseless (seamless) upgrade of the home appliance 10 may be performed.

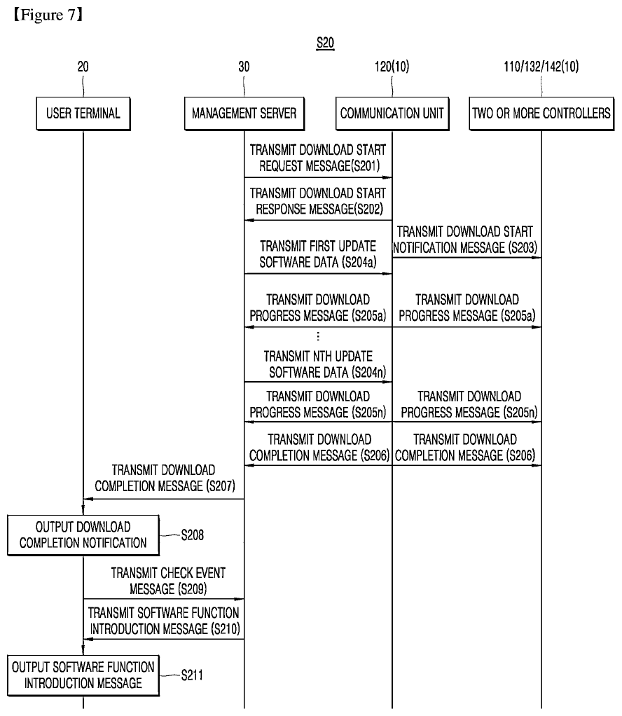

Hereinafter, some operations of the method of upgrading the home appliance 10 will be described in detail further with reference to FIGS. 6 to 9.

FIG. 6 is a flowchart of the preliminary process of the upgrade (S10) of the method of upgrading the home appliance 10 according to one embodiment of the present invention.

In FIG. 6, two or more controllers 110, 132, and 142 may be controllers except for the communication controller 122 among the plurality of controllers 122, 132, and 142 provided in the home appliance 10. The communication unit 120 may be provided in the home appliance 10. In addition, it is assumed that the communication unit 120 and the management server 30 are previously connected for communication.

Hereinafter, the preliminary process of the upgrade (S10) will be described in detail.

In S101, the two or more controllers 110, 132, and 142 may transmit information about the installed software to the communication unit 120. In other words, the two or more controllers 110, 132, and 142 may transmit the information about the installed software to the communication unit 120 through a local bus.

Here, the installed software may be software installed in each of the two or more controllers 110, 132, and 142 and may be firmware and/or a content program.

The firmware may be an operating program in charge of controlling and driving hardware. As described above, the two or more controllers 110, 132, and 142 may be operated based on different firmware.

The content program may be a service program related to the operation of the home appliance 10 and may be executed on specific firmware. As an example, in a washing machine, the content program may be a program for setting a background screen of a display unit of the washing machine, a program for setting a washing end notification sound, a program for setting the amount of input detergent/softener, and the like.

According to an embodiment, the information about the installed software may include version information of the installed software and list information of the installed software.

In S102, the communication unit 120 may store the information about the installed software in the storage 123.

In S103, the communication unit 120 may transmit the information about the installed software to the management server 30.

In S104, the management server 30 may set an upgrade cycle (i.e., an upgrade schedule) of the home appliance 10 based on the information about the installed software.

In other words, since the upgrade cycle may be different for each type of software, the management server 30 may set the upgrade cycle in consideration of the type of software. As an example, the management server 30 may set the upgrade cycle of software A to 7 days and the upgrade cycle of software B to 14 days.

In S105, the management server 30 may transmit upgrade cycle information to the communication unit 120. The upgrade cycle information may be stored in the storage 123.

Then, in S106, the communication unit 120 may transmit an upgrade inquiry message to the management server 30.

In other words, the upgrade cycle may be different depending on the type of software, and the communication unit 120 may transmit the upgrade inquiry message for each software type to the management server 30 based on upgrade cycle setting information.

In S107, the management server 30 may transmit an upgrade response message in response to the upgrade inquiry message.

The upgrade response message may be any one of a first upgrade response message or a second upgrade response message.

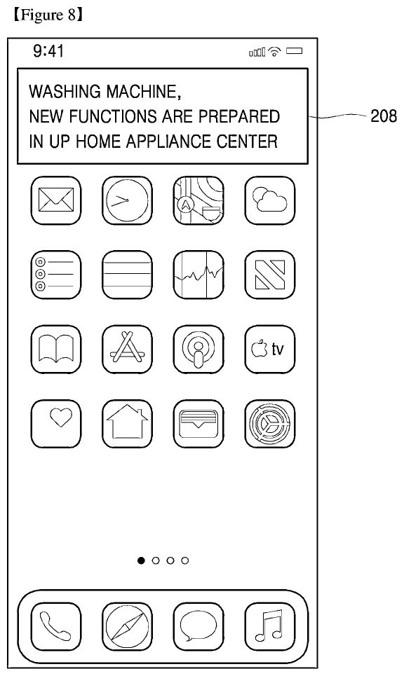

The first upgrade response message may be an upgrade response message transmitted from the management server 30 when specific software is upgraded. In other words, when upgrade software data on the specific software is stored in a server storage 330, the management server 30 may transmit the first upgrade response message to the communication unit 120. In this case, operations of FIG. 7 to be described below may be performed.

The second upgrade response message may be an upgrade response message transmitted from the management server 30 when the specific software is not upgraded. In this case, the home appliance 10 may not transmit the upgrade inquiry message to the management server 30 until the next cycle.

In summary, in S10, the upgrade cycle may be set automatically without user intervention. In other words, the upgrade cycle may be set by the management server 30 based on the information transmitted from the home appliance 10. S10 may be a pre-operation for performing the download process of the software data (S20) to be described below.

FIG. 7 is a flowchart of a download process (S20) of the method of upgrading the home appliance 10 according to one embodiment of the present invention.

In FIG. 7, it is also assumed that the communication unit 120 and the management server 30 are connected for communication in advance and the user terminal 20 and the management server 30 are also connected for communication in advance.

In addition, the download process (S20) may be performed when the above-described upgrade response message is transmitted from the management server 30 to the home appliance 10. In this case, it is assumed that N (an integer of 2 or more) pieces of software are upgraded.

Meanwhile, each of the N pieces of software may be software corresponding to the firmware or content program previously installed in the controller or new software corresponding to a new content program. Therefore, the term “software upgrade” described in the specification is defined as a concept which includes both “replacing an old version of software with a new version of software” and “installation of new software which has not been installed in the controller in advance.”

Hereinafter, the download process (S20) will be described in detail.

In S201, the management server 30 may transmit download start request message to the communication unit 120.

The download start request message may be a message which checks whether the communication unit 120 is ready to download N pieces of upgrade software data.

In S202, the communication unit 120 may transmit a download start response message, which is a response to the download start request message, to the management server 30. In other words, when the N pieces of upgrade software data are ready to be downloaded, the communication unit 120 may transmit the download start response message to the management server 30.

In S203, the communication unit 120 may transmit the download start notification message to the two or more controllers 110, 132, and 142. In other words, since subjects on which the N pieces of upgrade software are installed are the two or more controllers 110, 132, and 142, the communication unit 120 may transmit the download start notification message to the two or more controllers 110, 132, and 142 to satisfy backward compatibility. However, the communication unit 120 does not transmit the download start notification message to the management server 30. Therefore, the download process (S20) may be hidden from the user.

Meanwhile, S203 may be performed before the download starts.

In S204a, the management server 30 may transmit first upgrade software data among the N pieces of upgrade software data to the communication unit 120. The communication unit 120 may store the received first upgrade software data in the storage 123. When the transmission and storage of the first upgrade software data are finished, the download of the upgrade data on the first software among the N pieces of software may be finished.

In addition, in S205a in a process of transmitting the first upgrade software data, the communication unit 120 may transmit a download progress message on the first upgrade software data to the management server 30. In this case, the download progress message may be a message which reports a download progress in real time. In addition, to satisfy backward compatibility, the communication unit 120 may further transmit the download progress message on the first upgrade software data to the two or more controllers 110, 132, and 142.

Then, in S204n, the management server 30 may transmit nth upgrade software data among the N pieces of upgrade software data to the communication unit 120. The communication unit 120 may store the received nth upgrade software data in the storage 123. When the transmission and storage of the nth upgrade software data are finished, the download of the upgrade data on the nth software among the N pieces of software may be finished.

In addition, in S205n in a process of transmitting the nth upgrade software data, the communication unit 120 may transmit a download progress message on the nth upgrade software data to the management server 30. In addition, to satisfy backward compatibility, the communication unit 120 may further transmit the download progress message on the nth upgrade software data to the two or more controllers 110, 132, and 142.

In summary, in S204 including operations S204a to S204n, the management server 30 may collectively and sequentially upload the N pieces of upgrade software data to the home appliance 10, and the communication unit 120 may collectively and sequentially download the N pieces of upgrade software data. In addition, in S205 including operations S205a to S205n, the communication unit 120 may transmit the download progress message to the management server 30 and the two or more controllers 110, 132, and 142.

Meanwhile, the management server 30 and the communication unit 120 may be connected for communication through a wireless communication network or the like. In this case, a problem in which the download of a plurality of pieces of upgrade software data is stopped due to special circumstances such as the instability of the wireless communication network may occur. To solve such a problem, a taking-over process may be performed.

Specifically, when the download is interrupted, the communication unit 120 may transmit identification information of last received upgrade software data among the plurality of pieces of upgrade software data to the management server 30. In addition, the management server 30 may successively upload the plurality of pieces of upgrade software data based on the identification information. In other words, the management server 30 may transmit the next upgrade software data of the last received upgrade software data to the management server 30 based on the identification information. Therefore, it is possible to implement a seamless download process.

Subsequently, in S206, the communication unit 120 may transmit an upgrade completion message to the management server 30. At this time, for backward compatibility, the communication unit 120 may further transmit the download completion message to the two or more controllers 110, 132, and 142.

In S207, the management server 30 may transmit the download completion message to the user terminal 20.

In S208, the user terminal 20 may output a download completion notification based on the download completion message.

Meanwhile, as described above, the upgrade process may include a download process (S20) and a writing process (S30), and the writing process (S30) may be performed after the download process (S20) is finished. Therefore, the download completion notification may correspond to a writing start notification. Hereinafter, for convenience of description, the present embodiment will be described by replacing “download completion notification” with “writing start notification.”

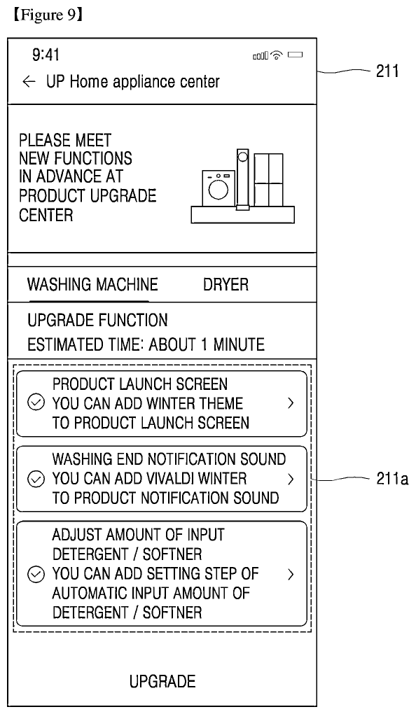

FIG. 8 is a view illustrating an example of the writing start notification.

Referring to FIG. 8, the terminal interface 230 may correspond to a display device. In addition, a writing start notification 208 may be visually displayed on the display device in a push manner. As an example, the writing start notification 208 may be a text such as “New functions are prepared in the UP Home Appliance Center.”

In this case, the user may perform an input event of selecting (touching) the writing start notification 208 to specifically check the functions of the new software corresponding to writing.

Referring back to FIG. 7, in S209, the user terminal 20 may transmit a check event message. The check event message is a message for checking the functions of the new software and may be generated by the input event.

In S210, the management server 30 may transmit a software function introduction message to the user terminal 20 based on the check event message.

In S211, the user terminal 20 may output the software function introduction message. The software function introduction message may include information introducing the functions of the new software. Therefore, the software function introduction message may correspond to a writing guide message. Hereinafter, for convenience of description, the present embodiment will be described by replacing “software function introduction message” with “writing guide message.”

FIG. 9 is a view illustrating an example of the writing guide message.

Referring to FIG. 9, the terminal interface 230 may correspond to the display device. In addition, a writing guide message 211 may include first information in the form of text which guides the writing process to the user. In particular, second information in the form of text introducing the functions of the new software may be displayed in a notification area 211a of the writing guide message 211.

Meanwhile, the writing process (S30) may be performed based on the writing guide message.

Specifically, referring to the example of FIG. 9, the user may check the second information about each of the three software (i.e., content programs) in the notification area 211a displayed on the user terminal 20.

Then, the user may select at least some software that he/she wants to upgrade (i.e., write) from the three pieces of second information. In other words, the user may upgrade all pieces of three software or only one software or two pieces of software. To this end, the user may input an event signal (touch signal), which selects software to be upgraded, to the user terminal 20.

The user terminal 20 may generate a selection message corresponding to the user's selection and transmit the selection message to the management server 30, and the management server 30 may transmit the received selection message to the communication unit 120.

The communication unit 120 may sequentially write at least some of the software data among the three pieces of downloaded upgrade software data based on the selection message to the corresponding controller. In other words, all of the three pieces of upgrade software data are not written, and only some may be written by the user's selection.

Hereinafter, the method of upgrading the home appliance 10 according to one embodiment of the present invention is summarized with reference to the above-described contents as follows.

The method of upgrading the home appliance according to one embodiment of the present invention is a method of upgrading the plurality of pieces of software, and after the download process is first performed collectively, the upgrade process may be collectively performed later.

As an example, it is assumed that the home appliance 10 includes first, second, and third controllers, and first firmware installed in the first controller, second firmware installed in the second controller, and third firmware installed in the third controller are upgraded together.

In the related art, the upgrade process of “downloading first firmware upgrade data→writing the first firmware upgrade data→downloading second firmware upgrade data→writing the second firmware upgrade data→downloading third firmware upgrade data→writing the third firmware upgrade data” is performed sequentially.

However, when the writing of the first firmware upgrade data is finished and the state of the wireless communication network deteriorates in the process of downloading the second firmware upgrade data, the downloading of the second firmware upgrade data is interrupted. Due to the interrupted download, the update data on not only the second firmware but also the third firmware is not written in the corresponding controller. In other words, the first firmware has been upgraded, but the second and third firmware are not upgraded.

In this case, a version of the first firmware for which the upgrade has been finished may be different from versions of the second and third firmware for which the upgrade has not been finished. In this case, due to the version difference, a problem in which the home appliance 10 itself does not operate occurs.

However, according to the method of upgrading the home appliance 10 according to one embodiment of the present invention, after the download process is first performed collectively, the upgrade process may be collectively performed later. In other words, the upgrade process of “downloading the first firmware upgrade data→downloading the second firmware upgrade data→downloading the third firmware upgrade data→writing the first firmware upgrade data→writing the second firmware upgrade data→writing the third firmware upgrade data” is performed sequentially.

Therefore, when the downloading of the first firmware upgrade data is finished and the state of the wireless communication network deteriorates in the process of downloading the second firmware upgrade data, the downloading of the second firmware upgrade data is interrupted. In this case, since the download process and the writing process are performed separately, none of the first, second, and third firmware are written in the corresponding controller. Therefore, the first, second, and third firmware may be the same version, and the home appliance 10 can be used normally even when the upgrade fails.

In addition, in the method of upgrading the home appliance according to one embodiment of the present invention, when the download of the plurality of pieces of software data is interrupted, the plurality of pieces of software data may be taken over. Therefore, the seamless upgrade of the home appliance 10 can be performed.

In addition, in the method of upgrading the home appliance according to one embodiment of the present invention, notifications related to the start and progress of the download are not provided to the user. In other words, the download process may be performed automatically without user intervention, and the user may check the download completion message for the first time in the upgrade process. Therefore, the user may check that the upgrade process is starting by checking the download completion message. In other words, from the perspective of the user, the download process may be hidden. In addition, as described above, the home appliance 10 may be used in the download process.

As a result, the user may use the home appliance 10 in a state of not knowing that the download process of the plurality of pieces of software data is in progress. In other words, from the perspective of the user, a start time of the upgrade may be a time at which the download completion message is checked. Therefore, from the perspective of the user, it is possible to shorten a performing time of the upgrade.

In addition, the upgrade of upgrading the home appliance 10 according to one embodiment of the present invention may provide the user with the function introduction information of the software to be upgraded. Therefore, the user may determine whether to perform the upgrade based on the function introduction information.

In particular, the function introduction information of software may be easily used when a new content program is upgraded. In other words, since a function of the new content program is a software function in which the user has not experienced, the function may be introduced to the user through the function introduction information of the software.

Meanwhile, when the new content program is upgraded, the corresponding firmware should also be modified. In other words, the new content program may be upgraded together with the corresponding firmware.

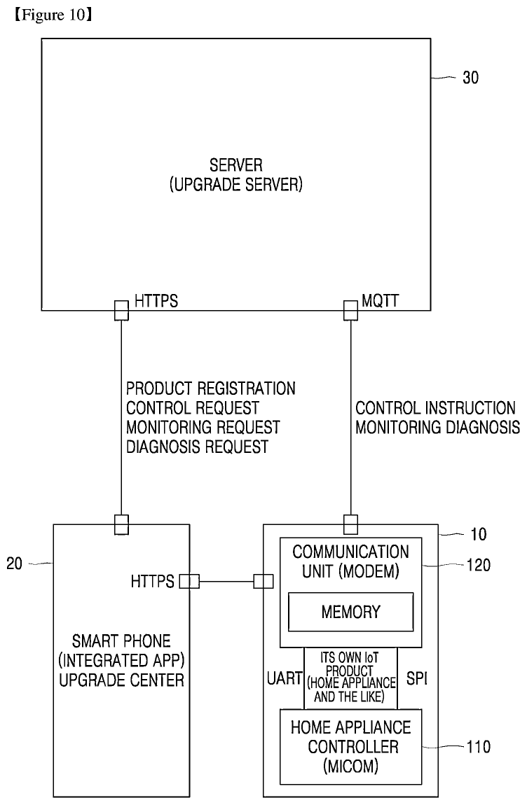

FIG. 10 is a view illustrating specific communication between the management server 30, the home appliance 10, and the user terminal 20 according to one embodiment of the present invention. Although only some components in the configuration of FIG. 2 are illustrated, the present invention is not limited thereto.

The management server 30 is a writing server for storing upgrade software and transmitting the upgrade software to the home appliance 10.

The user terminal 20 may set a network with the home appliance 10.

The home appliance 10 includes an electronic device for providing Internet of Things (IoT) functions. The home appliance 10 includes the communication unit 120 using a modem in one embodiment, and the main controller 110 (home appliance controller) using a microcomputer (micom) in one embodiment. In addition, the communication unit 120 includes the storage 123 using a memory in one embodiment.

The communication unit 120 and the main controller 110 may communicate using universal asynchronous receiver/transmitter (UART) and serial peripheral interface (SPI) communication protocols. Of course, in addition to the UART or the SPI, the communication unit 120 and the main controller 110 may transmit and receive information according to communication protocols, such as various serial/parallel communication methods and synchronous/asynchronous communication methods. The main controller 110 includes the function controller in charge of one or more functions of the home appliance 10, the interface controller capable of monitoring the functions and writing installation of products such as an LCD, an LED, a speaker, and a buzzer.

The management server 30 may communicate with the user terminal 20 using a hypertext transfer protocol secure (HTTPS) communication protocol. In one embodiment, the management server 30 and the user terminal 20 may perform product registration, control request, monitoring request, diagnosis request, and the like using the communication protocol (HTTPS).

In addition, the management server 30 may communicate with the home appliance 10 using a message queuing telemetry transport (MQTT) communication protocol. In one embodiment, the management server 30 and the home appliance 10 may perform control instructions, monitoring, diagnosis, and the like using the communication protocol (MQTT).

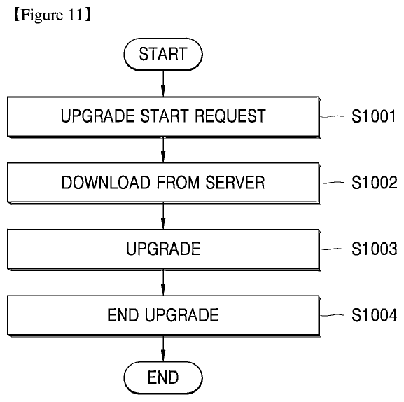

FIG. 11 shows an upgrade process according to another embodiment.

When the upgrade content to be applied to the home appliance is newly registered in the management server, the upgrade may be performed after selected and downloaded based on the flow chart of FIG. 11. This shows an embodiment in which the user selects and requests an upgrade before downloading to the home appliance and the download starts.

When software such as programs and data required for the upgrade is registered in the management server 30, the upgradeable software may be queried and a list of upgradable software may be displayed through the user interface 140 of the home appliance or the terminal interface 230 of the user terminal 20.

When the user selects one or more of upgradeable software through the user interface 140 of the home appliance 10 or the terminal interface 230 of the user terminal 20, the home appliance 10 or the user terminal 20 may requests the management server 30 to start the upgrade (S1001).

Hence, the home appliance 10 may download the selected software from the management server 30 (S1002). When the download is completed, the home appliance 10 may install and write the downloaded software in the home appliance controller to proceed with the upgrade (S1003).

Once the upgrade is completed (S1004), the home appliance 10 may perform re-booting. The user interface 140 of the home appliance 10 or the terminal interface 230 of the user terminal 20 may notify or display the upgraded function.

Even though all the components of the embodiments in the present disclosure are described as being combined into one component or operating in combination, embodiments are not limited to the embodiments set forth herein, and all the components can be selectively combined to operate within the scope of the purpose of the disclosure. All the components can be respectively implemented as an independent hardware, or some or all of the components can be selectively combined and can be embodied as a computer program including a program module that performs some or all functions combined into one or more hardware. Codes or code segments of the computer program can be easily inferred by those skilled in the art. The computer program can be stored in a computer-readable recording medium and can be read and executed by a computer, whereby the embodiments in the disclosure can be realized. Examples of a storage medium of the computer program include storage mediums including a magnetic recording medium, an optical recording medium and a semiconductor recording element. The computer program for realizing the embodiments in the disclosure includes a program module which is transmitted via an external device in real time.

Although the present invention has been described above with reference to specific details such as specific components and limited embodiments and drawings, it is only provided to help the overall understanding of the present invention, and the present invention is not limited to the above embodiments, and various modifications and variations can be made from the above description by those skilled in the art to which the present invention pertains. Therefore, the spirit of the present invention should not be limited to the described embodiments, and not only the appended claims but also all which are equivalent to the claims or have equivalent modifications fall within the scope of the spirit of the present invention.

1. A home appliance comprising:
a communication unit configured to communicate with a management server; and
a controller in which software is installed,
wherein the communication unit is configured to:
transmit an inquiry message of upgrade software to the management server based on a preset upgrade schedule; and
download upgrade software data transmitted from the management server based on the inquiry message.

2. The home appliance of claim 1, wherein the communication unit is configured to:
transmit information about the software to the management server; and
receive and store the upgrade schedule transmitted from the management server based on the information about the software.

3. The home appliance of claim 2, wherein the information about the software includes version information and list information of the software.

4. The home appliance of claim 1, wherein the communication unit includes a storage configured to store the upgrade software data.

5. The home appliance of claim 1, wherein the communication unit is configured to:
receive a download start request message from the management server;
transmit a download start response message, which is a response to the download start request message, to the management server; and
transmit a download start notification message to the controller and not transmit download start notification message to the management server before the download starts.

6. The home appliance of claim 1, wherein the communication unit is configured to:
transmit identification information of last received data among the upgrade software data to the management server when the download is interrupted; and
taking over the upgrade software data from the management server after a preset time based on the identification information of the last received data.

7. The home appliance of claim 1, wherein the upgrade software data includes at least one of upgrade firmware data corresponding to at least one firmware and upgrade content program data corresponding to at least one content program.

8. The home appliance of claim 1, wherein the upgrade software data includes upgrade firmware data corresponding to firmware and upgrade content program data executed on the firmware, and
the upgrade content program data is data on a new content program not installed in the home appliance.

9. The home appliance of claim 1, wherein the communication unit writes the downloaded upgrade software data in the controller, and
the upgrade software is installed in the controller.

10. (canceled)

11. A method of upgrading software of a home appliance performed by the home appliance, comprising:
checking whether upgrade software is present in a management server based on a preset schedule;
automatically downloading and storing upgrade software data from the management server when the upgrade software data corresponding to the upgrade software is registered in the management server; and
writing the downloaded upgrade software data in the controller of the home appliance and upgrading the software.

12. The method of claim 11, further comprising notifying the management server of the completion of the download of the upgrade software data after the downloading and storing,
wherein the upgrading includes writing the downloaded upgrade software data in the controller and upgrading the software based on a selection event of a user.

13. (canceled)

14. The method of claim 11, wherein the downloading and storing includes taking over and storing the upgrade software by re-trying the download of the upgrade software after a predetermined time has elapsed when the download of the upgrade software is interrupted.

15. A management server comprising:
a communication unit configured to communicate with a home appliance;
a storage configured to store upgrade software data corresponding to upgrade software executable in the home appliance; and
a controller configured to control the communication unit and the storage,
wherein the communication unit is configured to:
receive an inquiry message of upgrade software transmitted from the home appliance based on a preset upgrade schedule; and
sequentially upload the upgrade software data to the home appliance based on the inquiry message.

16. The management server of claim 15, wherein the communication unit is configured to:
receive information about software installed in the home appliance from the home appliance; and
transmit the upgrade schedule to the home appliance based on the information about the software.

17. The management server of claim 16, wherein the information about the software includes version information and list information of the software.

18. The management server of claim 15, wherein the communication unit is configured to:
transmit an inquiry response message, which is a response to the inquiry message, to the home appliance and then transmit a download start request message to the home appliance;
receive a download start response message, which is a response to the download start request message, from the home appliance; and
upload the upgrade software data to the home appliance based on the reception of the download start response message.

19. The management server of claim 15, wherein the communication unit is configured to:
receive identification information of last received data among the upgrade software data from the home appliance when the upload is interrupted; and
successively transmit the upgrade software data to the home appliance after a preset time based on the identification information of the last received data.

20. The management server of claim 15, wherein the upgrade software data includes at least one of upgrade firmware data corresponding to at least one firmware and upgrade content program data corresponding to at least one content program.

21. The management server of claim 15, wherein the upgrade software data includes upgrade firmware data corresponding to firmware and upgrade content program data executed on the firmware, and
the upgrade content program data is data on a new content program not installed in the home appliance.

22. The management server of claim 15, wherein the communication unit is configured to:
receive a download completion notification message corresponding to the completion of the upload from the home appliance;
transmit the download completion notification message to a user terminal;
receive a check event message on the download completion notification message from the user terminal; and
transmit a function introduction message of the upgrade software to the user terminal based on the check event message.

23. (canceled)
